(19) United States
(12) Patent Application Publication
(10) Pub. No.: US 2026/0098634 A1
(43) Pub. Date: Apr. 9, 2026

(54) BURNER LANCE, BURNER, BURNER ARRANGEMENT AND METHOD FOR CONTROLLING A BURNER LANCE

(71) Applicant: METSO FINLAND OY, Espoo (FI)

(72) Inventors: Andreas MUNKO, Friedrichsdorf (DE); Robert MADUTA, Hemsbach (DE); Matthias BERGMANN, Bad Homburg (DE)

(73) Assignee: METSO FINLAND OY, Espoo (FI)

(21) Appl. No.: 19/110,686

(22) PCT Filed: Sep. 13, 2022
(86) PCT No.: PCT/FI2022/050613

§ 371 Date: Mar. 11, 2025

(51) Int. Cl. F23D 14/24; F23D 14/58; F23D 17/00; F23N 1/02; F27D 99/00

(52) U.S. Cl. CPC F23D 14/24; F23D 14/58; F23D 17/00; F23N 1/02; F27D 99/0033

(57) ABSTRACT

A burner lance for industrial heating equipment includes a first fuel channel for fuel, the first fuel channel being provided with a first fuel outlet member at an outlet end of the burner lance. The burner lance further includes a first air channel for air, the first air channel being provided with a first air outlet member at the outlet end, and a second fuel channel for fuel, the second fuel channel being provided with a second fuel outlet member at the outlet end. At least the second fuel outlet member is provided with a widening member configured to widen the angle of the fuel flow exiting the burner lance outwards from the longitudinal axis of the burner lance. The first air channel is provided radially outwards from at least two of the fuel channels at the outlet end.

### BACKGROUND

The disclosure relates to industrial heating equipment, and more particularly to a burner lance, a burner, a burner arrangement, and a method for controlling a burner lance.

Inhomogeneous temperature distributions are present in the firing zone at various industrial heating devices and process engineering systems. This results in products of different quality.

Conventional burners, for instance burners for pellet systems, often have one outlet device for the fuel and one outlet device for the primary air. If the burner is to be operated with different fuels, especially in the case of widely different fuel gases, it generally has a separate outlet device for each fuel. This type of known solutions are static and inflexible, for example, with changed burner power, the resulting flow can be quite different from the intended.

US2015068438 discloses a biomass-mixed, pulverized coal-fired burner with five coaxial pipes/nozzles: two for air, one for pulverized coal fuel conveyed by pulverized coal fuel primary air, one for biomass fuel conveyed by biomass fuel primary air, and one optional for auxiliary or starting liquid or gas fuel when pulverized coal system fails. WO 2016180623 discloses a method for combustion of gaseous or liquid fuel using a burner assembly, wherein fuel, cold primary air and preheated air are supplied to a pre-chamber, whereby the fuel and cold primary air being supplied through at least one fuel feed and at least one primary air feed, and preheated combustion air is supplied to a combustion chamber.

### BRIEF DESCRIPTION OF THE DISCLOSURE

An object of the present disclosure is to provide a new burner lance, burner, burner arrangement and method for controlling a burner lance.

The object of the disclosure is achieved by a method and an apparatus which are characterized by what is stated in the independent claims. Some embodiments of the disclosure are disclosed in the dependent claims.

The disclosure is based on the idea of providing the burner lance with at least one channel for primary air and at least two channels for fuel, providing an outlet member of at least one of the fuel channels with a widening member, and providing the air channel radially outside at least two fuel channels at an outlet end of the burner lance.

An advantage of the disclosure is that a burner lance is provided, wherein the properties of the outgoing fuel or primary air flows can be greatly changed or kept constant as required by appropriate distribution of the total flows to the channels. In other words, a highly adjustable burner can be provided using such a burner lance.

### BRIEF DESCRIPTION OF THE DRAWINGS

In the following the disclosure will be described in greater detail by means of preferred embodiments with reference to the accompanying drawings, in which

FIG. 1 illustrates schematically a burner arrangement according to an embodiment;

FIG. 2 illustrates schematically a burner lance according to an embodiment seen from a side in cross section;

FIG. 3 illustrates schematically a burner lance according to a second embodiment seen from a side in cross section; and

FIG. 4 illustrates a method for controlling a burner lance.

The figures are provided for illustrating some features of the disclosure only and are not shown to scale. Same reference numbers are used for similar features in different figures and embodiments. Not all similar features are necessarily provided with reference numbers for the sake of clarity.

### DETAILED DESCRIPTION OF THE DISCLOSURE

In industrial heating equipment 1, burners 2 may be used for heating. Industrial heating equipment 1 may further comprise a combustion chamber 3, and one or more burners 2 may be provided on the combustion chamber 3. The combustion chamber 3 may, on the other hand, be mounted in an oven or a furnace 4.

A burner 2 may comprise a burner lance 10. Fuel and primary air may be configured to flow through the burner lance 10 and to enter, through the burner lance, the combustion chamber 3. In other words, primary air flow 25 and fuel flow 26 may be provided, more particularly supplied, to the burner lance 10. Process air 5 may be configured to enter the combustion chamber through its own channels. After ignition of the fuel/air mixture, a flame 6 is created resulting in a flow of hot gases, referred to as hot flow 27 in this disclosure. The flame is provided at least partially in the combustion chamber 3, but in some embodiments, the flame may also extend into a furnace 4. The flame 6 is configured to create a hot flow 27, in other words a flow of hot gases. According to an embodiment, the furnace 4 may comprise moving means 7, such as a conveyor belt and chained pallet cars, for moving the material to be heated in the furnace 4.

According to an embodiment, at least one end of the furnace 4 may comprise an opening and the hot flow(s) 27 may exit the furnace 4 through the opening. According to an embodiment, the hot flow, and the heated material, in other words the product, may exit the furnace 4 through the same end comprising the opening. According to another embodiment, such as an embodiment in connection with a pelletizing plant, the moving means 7 may comprise a porous material or a porous structure, and the hot flow 27 may exit the furnace 4 through the moving means.

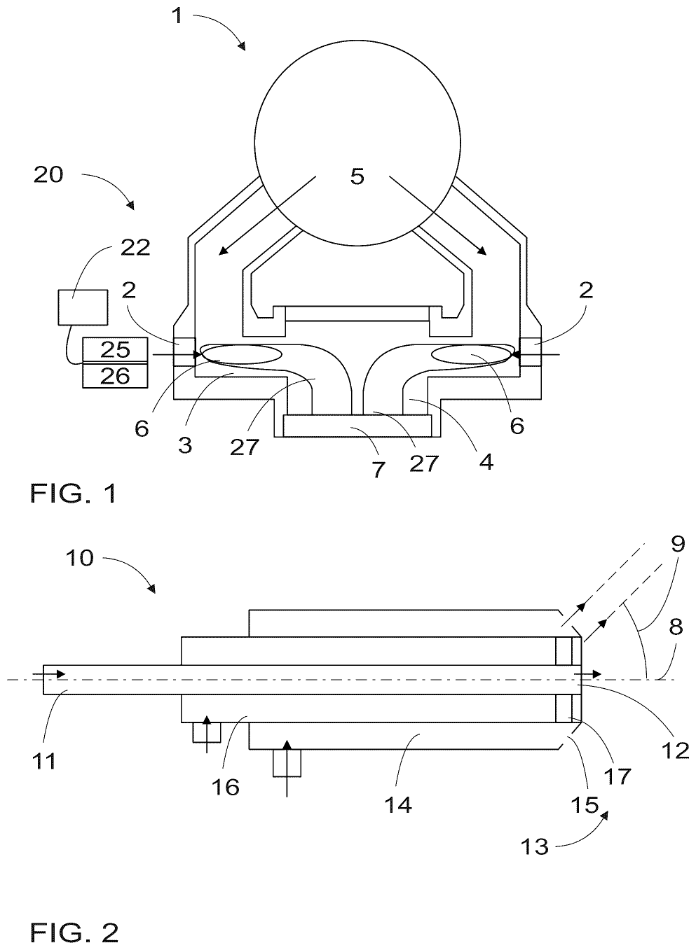

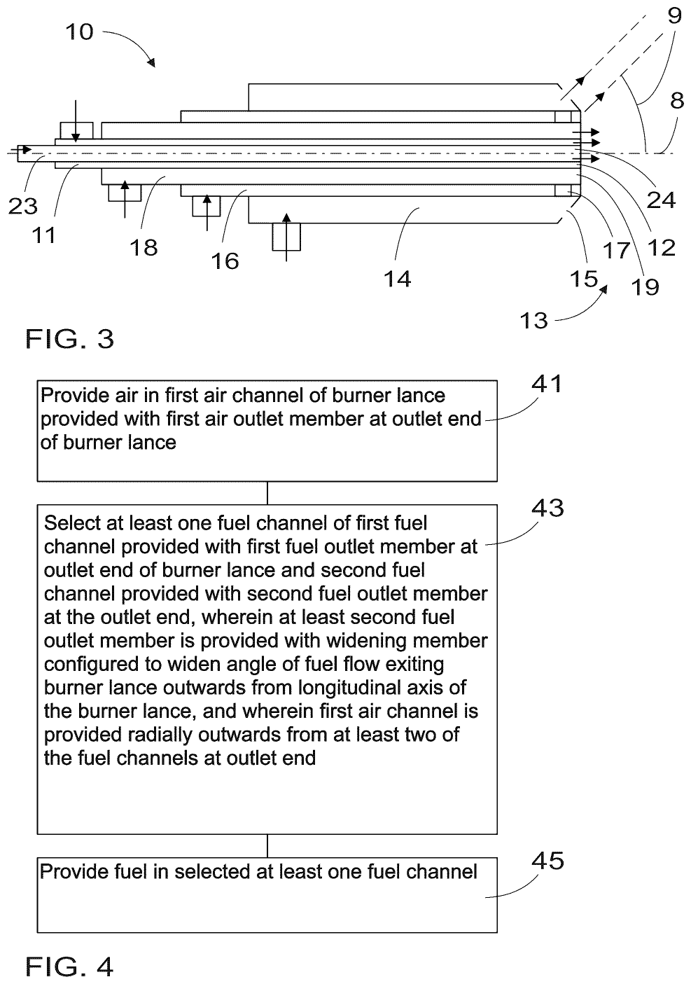

FIG. 1 illustrates schematically a burner arrangement 20 according to an embodiment, FIG. 2 illustrates schematically a burner lance 10 according to an embodiment seen from a side in cross section, and FIG. 3 illustrates schematically a burner lance 10 according to a second embodiment seen from a side in cross section.

This disclosure relates to industrial heating equipment 1, and more particularly to a burner lance 10, a burner 2, a burner arrangement 20 and a method for controlling a burner lance 10. The burner lance 10, burner 2, burner arrangement 20, and the method for controlling a burner lance 10 may be used in industrial heating equipment and/or in process engineering systems. According to an embodiment, the burner lance 10 and/or the burner 2 may be used for optimizing temperature distribution in the furnace. According to an embodiment, the burner lance 10, the burner 2 and/or the burner arrangement 20 may be used on straight grate pelletizing plants and, more particularly, used to optimize pellet quality. According to an embodiment, a burner arrangement 20 according to an embodiment or combination of embodiments disclosed in this disclosure may be configured to be used in connection with a straight grate pelletizing plant.

According to an embodiment, a straight grate pelletizing plant may comprise at least one of a burner lance 10, a burner 2 and burner arrangement 20 according to an embodiment or a combination of embodiments disclosed in this description and/or accompanying claims and/or drawings.

A burner lance 10 for industrial heating equipment, such as the burner lance 10 of FIG. 2 or 3, comprises a first fuel channel 11 for fuel. The first fuel channel 11 is provided with a first fuel outlet member 12 at an outlet end 13 of the burner lance 10. The burner lance 10 further comprises a first air channel 14 for air, more particularly for primary air. The first air channel 14 is provided with a first air outlet member 15 at the outlet end 13. The burner lance 10 further comprises a second fuel channel 16 for fuel, which the second fuel channel 16 is provided with a second fuel outlet member 17 at the outlet end 13.

The first air channel 14 is provided radially outwards from at least two of the fuel channels 11, 16, 18 at the outlet end 13.

At least the second fuel outlet member 17 may be provided with a widening member configured to widen the angle 9 of the fuel flow exiting the burner lance 10 outwards from the longitudinal axis 8 of the burner lance 10. According to an embodiment, a widening member, such as the widening member of the second fuel outlet member 17, comprises at least one of the following: a swirling member, a multi-hole plate with radially angled holes or a multi-hole plate with tangentially angled holes.

According to an embodiment, the first fuel outlet member 12 is not provided with a widening member. In other words, according to an embodiment, the first fuel outlet member 12 does not comprise a widening member and the second fuel outlet member 17 comprises a widening member. According to an embodiment, the burner lance 10 may comprise further fuel channels and fuel outlet members which may or may not comprise a widening member at the outlet end 13. According to an embodiment, the first fuel outlet member 12 may comprise an outlet member in a form of a nozzle, an annular opening, or a multi-hole plate.

According to an embodiment, a widening member, such as the widening member of the second fuel outlet member 17, is configured to cause an angle 9 of the fuel flow exiting the burner lance 10 of at least 15 degrees with respect to a direction of the longitudinal axis 8 of the burner lance 10 at the outlet end 13. According to another embodiment, the widening member, such as the widening member of the second fuel outlet member 17, is configured to cause an angle 9 of the fuel flow exiting the burner lance 10 of at least 17 degrees with respect to a direction of the longitudinal axis 8 of the burner lance 10 at the outlet end 13. According to a further embodiment, the widening member, such as the widening member of the second fuel outlet member 17, is configured to cause an angle 9 of the fuel flow exiting the burner lance 10 of at least 20 degrees with respect to a direction of the longitudinal axis 8 of the burner lance 10 at the outlet end 13. The angle 9 of the fuel flow exiting the burner lance 10 may also be called a jet angle.

According to an embodiment, the first fuel outlet member 12, the second fuel outlet member 17 and the first air outlet member 15 are provided concentrically with respect to one another. In other words, the first fuel channel 11, the second fuel channel 16 and the first air channel 14 may be provided concentrically with respect to one another at least at the outlet end 13 of the burner lance 10. According to an embodiment, the first fuel outlet member 12, the second fuel outlet member 17 and the first air outlet member 15 are provided concentrically with one another and with the longitudinal axis 8 of the burner lance 10.

According to an embodiment, the first fuel channel 11 may comprise an innermost channel at the outlet end 13, and the second fuel channel 16 may be provided radially outwards from the first fuel channel 11 at the outlet end 13. In other words, the second fuel outlet member 17 may be provided radially outwards from the first fuel outlet member 12.

According to an embodiment, the first air channel 14 may be provided radially outwards from the second fuel channel 16 at the outlet end 13. In other words, the first air outlet member 15 may be provided radially outwards from the second fuel outlet member 17.

According to an embodiment, such as the embodiment of FIG. 3, the burner lance 10 may further comprise a third fuel channel 18 for fuel. The third fuel channel 18 may be provided with a third fuel outlet member 19 at the outlet end 13. According to an embodiment, the third fuel outlet member 19 may comprise an outlet member in a form of a nozzle, an annular opening or a multi-hole plate and is not provided with a widening member. According to another embodiment, the third fuel outlet member 19 may comprise a widening member.

According to an embodiment, the third fuel channel 18 may be provided between the first fuel channel 11 and the second fuel channel 16 at the outlet end 13. In other words, the third fuel outlet member 19 may be provided between the first fuel outlet member 12 and the second fuel outlet member 17, such as in FIG. 3.

Some embodiments for the order, in which the outlet members 12, 15, 17, 19, 24 may be provided at the outlet end of the burner lance 10, are presented in Table 1, which is not an exhaustive list by any means. The number of fuel channels and the number of air channels refer to the minimum number of respective channels in each embodiment. It should be noted that in some further embodiments, further channels, for instance further air channels and/or further fuel channels with or without widening members, may be provided inside, outside or between channels listed in Table 1. It should also be noted that in the embodiments of Table 1, the air channels with widening member may be replaced by air channels without a widening member.

In Table 1, FW refers to a fuel outlet member comprising a widening member, FN refers to a fuel outlet member comprising no widening member, AW refers to an air outlet member comprising a widening member and AN refers to an air outlet member comprising no widening member. In Table 1, the channels are numbered from an innermost channel to the outermost channel in such a manner that channel 1 is the innermost of the channels listed, in other words the one closest to the longitudinal axis 8 of the burner lance 10. The row Fuel channels refers to the minimum number of fuel channels in the embodiment in question and Air channels refers to the minimum number of air channels in the embodiment in question.

TABLE 1

| | Embodiment | | | | | | | | |
|---|---|---|---|---|---|---|---|---|---|
| | 1 | 2 | 3 | 4 | 5 | 6 | 7 | 8 | 9 |
| | Number of fuel channels | | | | | | | | |
| | 2 | 2 | 3 | 3 | 3 | 3 | 3 | 3 | 3 |
| Chan- | Number of air channels | | | | | | | | |
| nels | 1 | 1 | 1 | 1 | 1 | 1 | 1 | 1 | 2 |
| 1 | FW | FN | FN | FN | FN | FN | FW | FW | AN |
| 2 | FW | FW | FN | FN | FW | FW | FN | FN | FN |
| 3 | AW | AW | FW | AW | FW | AW | FW | AW | FW |
| 4 | | | AW | FW | AW | FW | AW | FW | FW |
| 5 | | | | | | | | | AW |

According to an embodiment, outlet surfaces of the first fuel outlet member 12, the second fuel outlet member 17 and/or the third fuel outlet member 19 may be of different sizes. In other words, the cross-sectional areas of the first fuel outlet member 12, the second fuel outlet member 17 and/or the third fuel outlet member 19 may be different.

According to an embodiment, at least two of the outlet surfaces of the first fuel outlet member 12, the second fuel outlet member 16 and/or the third fuel outlet member 19 are of a same size. In other words, the cross-sectional areas of at least two of the first fuel outlet member 12, the second fuel outlet member 17 and the third fuel outlet member 19 may be equal.

The outlet surface of an outlet member 12, 15, 17, 19 refers to the combined area of the opening(s) provided at the outlet end 13 of the corresponding channel 11, 14, 16, 18. The outlet surface of each outlet member 12, 15, 17, 19 may, thus, be formed of one or more openings connecting the corresponding channel 11, 14, 16, 18 to the combustion chamber 3.

According to an embodiment, the burner lance 10 may further comprise a second air channel for air 23, the second air channel 23 being provided concentrically with respect to the first fuel channel 11, the second fuel channel 16 and the first air channel 14 and provided with a second air outlet member 24 at the outlet end 13. According to an embodiment, at least one of the first air outlet member 15 and the second air outlet member 24 may comprise a widening member. According to an embodiment, the first air outlet member 15 comprises a widening member.

According to an embodiment, a burner 2 may comprise a burner lance 10 according to an embodiment or combination of embodiments disclosed in this description and/or accompanying drawings. According to an embodiment, such a burner 2 is mounted in a combustion chamber 3 of an oven.

According to an embodiment, a burner arrangement 20 may comprise at least one burner 2 disclosed in this description, wherein the burner arrangement 20 may further comprise a valve arrangement 22 configured to selectively enable and block flow of air, more particularly primary air, and fuel from air supply and fuel supply respectively to each one of the air channel(s) 14, 23 and fuel channels 11, 16, 18 respectively. According to an embodiment, where there are two fuel channels 11, 16, in a use situation of the firing system 20 the ratio of fuel supply may be such that 100 percent of the fuel flow is supplied to one of the fuel channels and 0 percent to the other one, or the ratio may be 70 percent and 30 percent, and so on. According to an embodiment, enabling flow of fuel or primary air to a channel may comprise providing a percentage larger than 0 and a maximum of 100 percent of the total fuel or air flow to that channel. Such fuel supply ratios are discussed later in this description in more detail. Similarly, air supply ratio may refer to the extent to which, if any, air is supplied to a specific air channel and/or divided between specific air channels. The selection of the air channels(s) 14, 23 and the fuel channels 11, 16, 18, the fuel supply ratio and/or the air supply ratio to these channels results in a certain speed of the outgoing fuel flow and/or speed of the outgoing air flow. The speed and direction of the outgoing fuel flow and the outgoing air flow, on the other hand, result in a certain flow pattern of the hot flow 27.

FIG. 4 illustrates a method for controlling a burner lance 10.

A method for controlling a burner lance 10 for industrial heating equipment, such as the method of FIG. 4, may comprise providing 41 air in a first air channel 14 of the burner lance 10 provided with a first air outlet member 15 at an outlet end 13 of the burner lance 10. The method may further comprise selecting 43 at least one fuel channel of a first fuel channel 11 provided with a first fuel outlet member 12 at an outlet end 13 of the burner lance 10 and a second fuel channel 16 provided with a second fuel outlet member 17 at the outlet end 13, wherein at least the second fuel outlet member 17 is provided with a widening member configured to widen the angle 9 of the fuel flow exiting the burner lance 10 outwards from the longitudinal axis 8 of the burner lance 10. The first air channel 14 may be provided radially outwards from at least two of the fuel channels at the outlet end 13. The method may further comprise providing 45 fuel in the selected at least one fuel channel 11, 16, 18. Thereby, outgoing flow of fuel from the burner lance 10 at a given fuel flow supply may be controlled by the selection of the fuel channel(s), to which fuel is provided. More particularly, mass flow, flow speed and/or flow direction may be controlled by the selection of fuel channel(s).

According to an embodiment, the method further comprises adjusting at least one of a speed of the outgoing fuel flow, and a flow pattern of a hot flow 27 by the control of outgoing flow of fuel from the burner lance 10. According to an embodiment, the speed of the outgoing fuel flow comprises an average speed of the outgoing fuel flow from the fuel channels 11, 16, 18. More particularly, the speed of the outgoing fuel flow comprises an average speed of the outgoing fuel flow from the fuel channels 11, 16, 18 to which fuel is supplied. The flow pattern of the hot flow 27 may comprise a length, shape, and speed of the hot flow 27. Similarly, the flame 6 may comprise a flow pattern comprising a length, shape, and speed of the flame 6, and the flow pattern of the flame 6 and/or the speed and direction of the outgoing fuel flow may affect the flow pattern of the hot flow 27.

According to an embodiment, the control of outgoing flow of fuel from the burner lance may be controlled with help of the valve arrangement 20.

According to an embodiment, the method may further comprise selecting, to ignite a flame, a first fuel supply ratio between the fuel channels, and selecting, after ignition, a second fuel supply ratio between the fuel channels, and wherein the first fuel supply ratio is different from the second supply ratio. According to an embodiment, the method may further comprise selecting a third fuel supply ratio between the fuel channels, wherein the third fuel supply ratio is different from at least one of the first fuel supply ratio and the second fuel supply ratio, and preferably different from both the first fuel supply ratio and the second fuel supply ratio. According to an embodiment, the method may comprise selecting the third fuel supply ratio after the second fuel supply has been used for a predetermined time and/or when the furnace 4 reaches a predetermined temperature. According to an embodiment, each one of the first fuel supply ratio, the second fuel supply ratio, and the third fuel supply ratio comprises a ratio of fuel supplied to each one of the fuel channels 11, 16, 18. In other words, the fuel supply ratio defines the percentage of the total fuel supply that is supplied to each one of the fuel channels. According to an embodiment, where there are two fuel channels 11, 16, one of the ratios may be 100 percent to one of the fuel channels and 0 percent to the other one, or 70 percent and 30 percent. In embodiments, where there are more than three fuel channels, the total of the percentages supplied to the three fuel channels 11, 16, 18 may, naturally, be less than 100 percent, as the rest may be provided to the further fuel channels. According to an embodiment comprising more than one air channels, an air supply ratio for different use situations may be determined in a similar manner.

An advantage of the burner lance 10, the burner 2 and the burner arrangement 20 embodiments disclosed in this description is that the burner lance 10 has several separate channels and coordinated outlet members for fuel and primary air. Thereby, the supply of fuel flow 26 and primary air flow 25 to the individual air and fuel channels may be such that the properties of the outgoing fuel or primary air flows can be greatly changed or kept constant as required by appropriate distribution of the total flows to the channels.

1. A burner lance for industrial heating equipment, the burner lance comprising:
a first fuel channel for fuel, the first fuel channel being provided with a first fuel outlet member at an outlet end of the burner lance;
a first air channel for air, the first air channel being provided with a first air outlet member at the outlet end; and
a second fuel channel for fuel, the second fuel channel being provided with a second fuel outlet member at the outlet end,
wherein at least the second fuel outlet member is provided with a widening member configured to widen the angle of the fuel flow exiting the burner lance outwards from the longitudinal axis of the burner lance, and
wherein the first air channel is provided radially outwards from at least two of the fuel channels at the outlet end, and
wherein the first fuel outlet member, the second fuel outlet member and the first air outlet member are provided concentrically with respect to one another at least at the outlet end of the burner lance.

2. The burner lance according to claim 1, wherein the first fuel outlet member is not provided with a widening member, and wherein the first fuel outlet member comprises an outlet member in a form of a nozzle, an annular opening, or a multi-hole plate.

3. (canceled)

4. The burner lance according to claim 1, wherein the widening member comprises at least one of the following: a swirling member, a multi-hole plate with radially angled holes or a multi-hole plate with tangentially angled holes; and wherein the widening member is configured to cause an angle of the fuel flow exiting the burner lance of at least 15 degrees with respect to a direction of the longitudinal axis of the burner lance at the outlet end.

5. (canceled)

6. (canceled)

7. The burner lance according to claim 1, wherein the first fuel channel comprises an innermost channel at the outlet end, and the second fuel channel is provided radially outwards from the first fuel channel at the outlet end.

8. The burner lance according to claim 1, wherein the first air channel is provided radially outwards from the second fuel channel at the outlet end.

9. The burner lance according to claim 1, wherein the burner lance further comprises a third fuel channel for fuel, the third fuel channel being provided with a third fuel outlet member at the outlet end, and wherein the third fuel outlet member comprises an outlet member in a form of a nozzle, an annular opening or a multi-hole plate and is not provided with a widening member.

10. (canceled)

11. The burner lance according to claim 9, wherein the third fuel channel is provided between the first fuel channel and the second fuel channel at the outlet end.

12. (canceled)

13. (canceled)

14. (canceled)

15. (canceled)

16. A burner, wherein the burner comprises the burner lance according to claim 1.

17. The burner according to claim 16, wherein the burner is mounted in a combustion chamber of an oven.

18. A burner arrangement comprising at least one burner according to claim 16, wherein the burner arrangement further comprises a valve arrangement configured to selectively enable and block flow of air and fuel from air supply and fuel supply to each one of the air channel(s) and fuel channels respectively.

19. (canceled)

20. A straight grate pelletizing plant comprising the burner lance according to claim 1.

21. A method for controlling a burner lance for industrial heating equipment, the method comprising:
providing air in a first air channel of the burner lance provided with a first air outlet member at an outlet end of the burner lance;
selecting at least one fuel channel of a first fuel channel provided with a first fuel outlet member at an outlet end of the burner lance and a second fuel channel provided with a second fuel outlet member at the outlet end, wherein at least the second fuel outlet member is provided with a widening member configured to widen the angle of the fuel flow exiting the burner lance outwards from the longitudinal axis of the burner lance, and wherein the first air channel is provided radially outwards from at least two of the fuel channels at the outlet end; and
providing fuel in the selected at least one fuel channel,
whereby outgoing flow of fuel from the burner lance at a given fuel flow supply is controlled by the selection of the fuel channel(s), to which fuel is provided.

22. The method according to claim 21, wherein the method comprises adjusting at least one of a speed of the outgoing fuel flow and a flow pattern of a hot flow by the control of outgoing flow of fuel from the burner lance.

23. The method according to claim 22, wherein the speed of the outgoing fuel flow comprises an average speed of the outgoing fuel flow from the fuel channels.

24. (canceled)

25. (canceled)

26. The method according to claim 21, wherein the method further comprises:
selecting, to ignite a flame, a first fuel supply ratio between the fuel channels, and
selecting, after ignition, a second fuel supply ratio between the fuel channels, and
wherein the first fuel supply ratio is different from the second supply ratio.

27. A straight grate pelletizing plant comprising the burner according to claim 8.

28. A straight grate pelletizing plant comprising the burner arrangement according to claim 18.
